(19) United States
(12) Patent Application Publication
(10) Pub. No.: US 2006/0222833 A1
(43) Pub. Date: Oct. 5, 2006

(54) Imprinting mold for printed circuit board having excellent durability and method of manufacturing printed circuit board using the same

(75) Inventors: Il Sang Maeng, Gyeonggi-do (KR); Myeong Ho Hong, Gyeonggi-do (KR); Choon Keun Lee, Gyeonggi-do (KR); Jeong Bok Kwak, Gyeonggi-do (KR); Jae Choon Cho, Gyeonggi-do (KR); Seung Hyun Ra, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/327,111

(22) Filed: Jan. 6, 2006

(30) Foreign Application Priority Data
Mar. 31, 2005 (KR) 10-2005-0027121

(51) Int. Cl. B05D 5/12; B32B 7/00

(52) U.S. Cl. 428/209; 427/96.1; 427/97.7; 428/901

(57) ABSTRACT

The present invention relates to an imprinting mold for a printed circuit board, having excellent durability, and a method of manufacturing a printed circuit board using the same. Specifically, this invention provides an imprinting mold for a printed circuit board, having excellent durability, in which the mold having a surface structure corresponding to a plurality of via holes and a pattern to be formed is prepared by incorporating 30-80 parts by weight of a filler, having an average particle size of 0.1-5.0 μm, into 100 parts by weight of a heat or UV curing prepolymer. In addition, a method of manufacturing a printed circuit board using the imprinting mold is provided.

### INCORPORATION BY REFERENCE

The present application claims priority under 35 U.S.C. §119 to Korean Patent Application No. 10-2005-0027121 filed on Mar. 31, 2005. The content of the application is incorporated herein by reference in its entirety.

### BACKGROUND OF THE INVENTION

1. Field of the Invention

The present invention relates, generally, to an imprinting mold for a printed circuit board (PCB), having excellent durability, and a method of manufacturing a PCB using the same. More particularly, the present invention relates to an imprinting mold for a PCB having excellent durability, which is advantageous because it is prepared by incorporating a filler into a prepolymer for an imprinting mold to increase the durability thereof and extending the lifetime thereof, and to a method of manufacturing a PCB using the imprinting mold.

2. Description of the Related Art

Presently, electronic and electrical techniques have been rapidly developed to store information having larger capacities, to process and transfer information faster, and to construct a simpler information communication network, in order to realize the highly information-intensive society of the 21ₛₜ century.

However, since an information transfer speed is limited, the above requirements are expected to be satisfied in a manner such that constituent devices are manufactured as small as possible and reliability is simultaneously increased to provide new functions.

According to the recent trend toward the fabrication of electronic products to be light, slim, short and small, a PCB is also required to be finely patterned, miniaturized and packaged. Thus, there is need for the preparation of a highly dense substrate (line/space≦10 μm/10 μm, microvia<30 μm) in order to realize a circuit having outstanding signal processability in a smaller area.

Techniques for manufacturing a fine structure, widely used to date, include photolithography, which is a process of forming a pattern on a substrate coated with a photo-resist thin film.

However, the preparation of the substrate using a UV lithographic process suffers because a thick copper foil is required to serve as a circuit and a wet etching process is conducted. Hence, in the case where a fine line/space of 10 μm or less is formed using UV lithography, unreliable products may result.

In this way, the UV lithographic process used for the preparation of a substrate to date causes problems in terms of manufacturing cost, as well as accuracy and reliability of the manufacturing process, in proportion to an increase in the density of the substrate.

Recently, while the degree of integration of a PCB is further increased, thorough research into fine pattern formation methods is being conducted. In this regard, attempts to manufacture a highly dense substrate using an imprinting process, instead of the UV lithographic process, have been made.

The imprinting process is classified depending on the type of mold used. For instance, when a hard metal or ceramic is used for a mold, a process requiring high temperature and high pressure should be conducted to form a uniform pattern on the substrate.

Hence, as techniques for controlling the structure and composition of a material to be specifically used at the atomic/molecular level, a method of using a polymer material has been studied and developed.

Moreover, since the polymer has wide applications from selective etching resist, optical devices and biochemical sensors to tissue engineering, it is expected to greatly affect the development of next-generation new material and has received attention in recent years.

In particular, when a nano-sized fine pattern is formed using a polymer thin film, a conventional imprinting process may be used.

Such a nanoimprinting process, which has been invented by Stephen Chou et. al., Princeton University, USA, (U.S. Pat. No. 5,772,905), is known to be suitable for the formation of a fine semiconductor pattern, etc., by manufacturing a necessary shape on a material having a relatively high strength and then imprinting the material into another material for patterning. The same inventor has proposed the application of the same technique to a nano-compact optical disk (U.S. Pat. No. 6,518,189). The nanoimprinting process is advantageous because it can overcome the problem of low productivity, thus a nano-sized fine pattern can be prepared on a large scale.

When a large substrate such as a PCB is manufactured using the imprinting process, the imprinting process should be conducted on a large area for mass production. To this end, methods of using an elastic polymer for a mold have recently been devised.

In this regard, a conventional method of preparing an imprinting mold is sequentially illustrated in FIG. 1.

As shown in FIG. 1, a prepolymer solution 20 having flowability is introduced into a master 10 having a surface structure corresponding to a plurality of via holes and a pattern to be formed, thereby equally transferring the pattern of the master 10 to the prepolymer. In this state, the prepolymer is cured using heat or UV light, after which an imprinting mold 30 is removed from the master 10. Thus, the resulting pattern has some degree of mechanical strength. As such, although a process of varying the mechanical properties of a final mold by designing the molecular form of the prepolymer has been actively studied to date, it imposes limits on the extent of variation of the mechanical properties of the mold.

In the case where the imprinting technique is employed to form a circuit and a via hole in a PCB, since process conditions of high temperature and high pressure are required to imprint a resin having high viscosity, the lifetime of the mold may be shortened due to the stress applied to the mold.

As mentioned above, the current technique of imprinting a PCB using a mold made of a polymer is disadvantageous because the polymer mold is repeatedly used, thus decreasing the durability and lifetime thereof. Presently, however, techniques for alleviating such problems have not yet been developed.

### SUMMARY OF THE INVENTION

Leading to the present invention, intensive and thorough research into imprinting molds for PCBs, carried by the present inventors aiming to avoid the problems encountered in the related art, resulted in the finding that a predetermined amount of filler having a predetermined average particle size may be incorporated into a polymer to obtain an imprinting mold having excellent durability, suitable for use in a large PCB having a μm sized structure.

Accordingly, an object of the present invention is to provide an imprinting mold for a PCB, which can have improved durability and can be repeatedly used.

Another object of the present invention is to provide a method of manufacturing a PCB using the imprinting mold.

In order to accomplish the above objects, the present invention provides an imprinting mold for a PCB, having excellent durability, in which the mold having a surface structure corresponding to a plurality of via holes and a pattern to be formed is prepared by incorporating 30-80 parts by weight of a filler having an average particle size of 0.1-5.0 μm into 100 parts by weight of a heat or UV curing prepolymer.

In the imprinting mold, the prepolymer is selected from the group consisting of polyurethane, polyester, silicone rubber, epoxy, teflon, and combinations thereof.

In the imprinting mold, the filler is selected from the group consisting of silica, glass frit, clay, carbon black, alumina, and combinations thereof.

The filler is preferably surface treated with any one compound selected from the group consisting of compounds represented by Formulas 1 to 4 below:

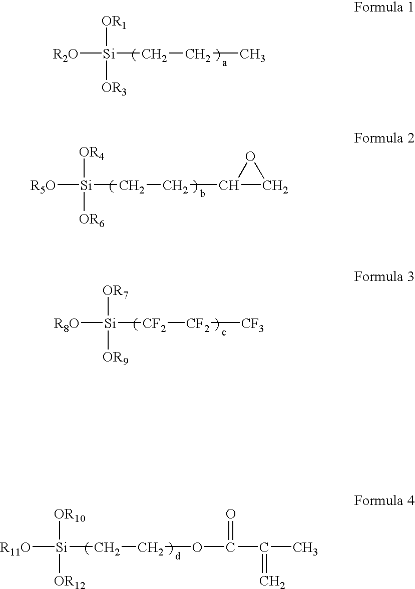

in Formulas 1 to 4, R₁ to R₁₂ are the same or different, each being an alkyl group of 1-20 carbons, and a, b, c and d are the same or different, each being an integer from 1 to 15.

In addition, the present invention provides a method of manufacturing a PCB, including providing an imprinting mold having a surface structure corresponding to a plurality of via holes and a pattern to be formed; providing a substrate including a conductive metal layer and a semi-cured resin insulating layer laminated thereon; placing the imprinting mold on the resin insulating layer of the substrate, and compressing the imprinting mold and the resin insulating layer of the substrate at a predetermined temperature under predetermined pressure to imprint the resin insulating layer of the substrate with the imprinting mold; removing the imprinting mold from the substrate, to form the imprinted via holes and pattern corresponding to the structure of the mold in the resin insulating layer of the substrate; and plating the resin insulating layer having the imprinted via holes and pattern with a conductive metal, to form via holes and a circuit pattern for electrical connection between circuits.

The method further includes applying a release agent on the structure of the imprinting mold, before the placing the imprinting mold step.

In the method of the present invention, the conductive metal is preferably selected from the group consisting of silver, gold, platinum, palladium, copper, nickel, iron, aluminum, molybdenum, tungsten, alloys thereof, and mixtures thereof.

### BRIEF DESCRIPTION OF THE DRAWINGS

FIG. 1 is schematic perspective views sequentially showing a conventional process of preparing an imprinting mold; and;

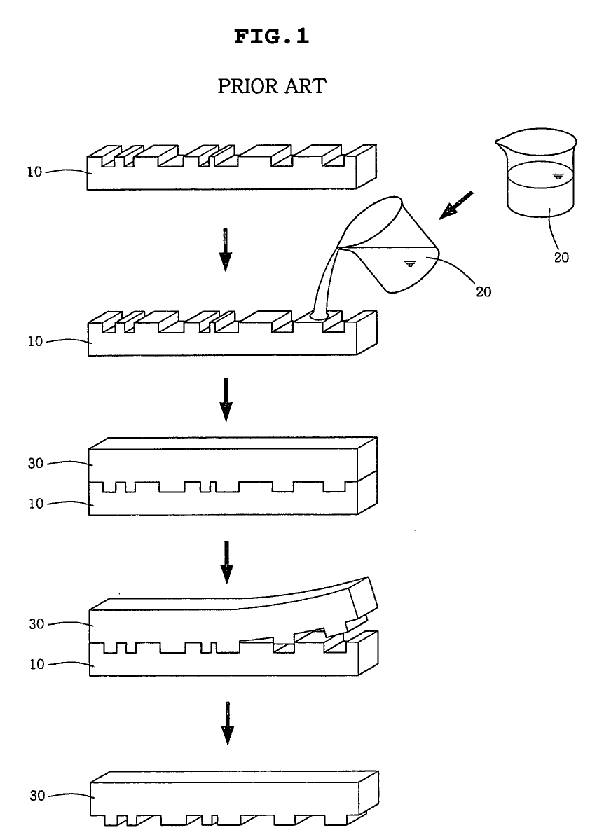

FIG. 2 is a schematic cross-sectional view showing an imprinting mold for a PCB, according to the present invention.

### DETAILED DESCRIPTION OF THE INVENTION

Hereinafter, a detailed description will be given of the present invention, with reference to the appended drawings.

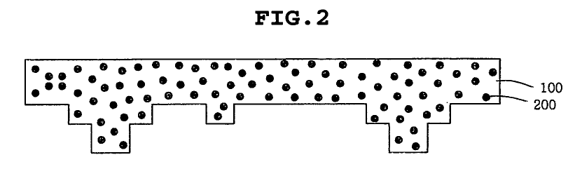

FIG. 2 is a cross-sectional view showing an imprinting mold for a PCB, according to the present invention.

The imprinting mold for the PCB of the present invention is prepared by adding a predetermined amount of filler 200 to a heat or UV curing prepolymer 100 to obtain a uniform dispersion, which is then introduced into a master mold and cured using heat or UV light.

The prepolymer 100 used in the present invention is a general heat or UV curing resin, and can be selected from the group consisting of polyurethane, polyester, silicone rubber, epoxy, teflon, and combinations thereof, but is not particularly limited thereto.

In addition, the filler 200 used in the present invention can be selected from the group consisting of silica, glass frit, clay, carbon black, alumina, and combinations thereof, but is not particularly limited thereto.

The filler has an average particle size of 0.1-5.0 μm, and preferably 0.1-1.0 μm. Filler having an average particle size smaller than 0.1 μm is difficult to treat, whereas filler exceeding 5.0 μm is unsuitable for use in the formation of a fine pattern.

Further, in order to improve dispersion stability of the filler, it is preferable that the filler be surface treated with any one compound selected from the group consisting of compounds represented by Formulas 1 to 4 below:

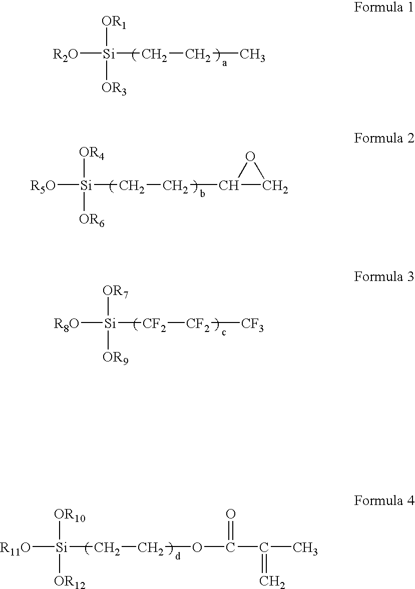

In Formulas 1 to 4, R₁ to R₁₂ are the same or different, each being an alkyl group of 1-20 carbons, and a, b, c and d are the same or different, each being an integer from 1 to 15.

The filler is used in an amount of 30-80 parts by weight, and preferably 30-70 parts by weight, based on 100 parts by weight of the prepolymer. If the amount of filler is less than 30 parts by weight, it is difficult to improve the durability of the mold using the filler. On the other hand, the use more than 80 parts by weight of the filler results in an inelastic mold.

The process of uniformly dispersing the filler 200 in the heat or UV curing prepolymer 100 is not particularly limited as long as it is known to those skilled in the art. For example, in the case of using silica as the filler, a process of condensing a silane compound having an alkyl group with silica to form a covalent bond may be applied.

Also, the mold composition of the present invention may further include an additive, such as a curing accelerator, a colorant, etc., if necessary.

The imprinting mold of the present invention has a structure corresponding to a plurality of via holes and a pattern to be formed, which is prepared in a relatively large μm size (e.g., line/space≦10 μm/10 μm, microvia≦30 μm), unlike when applied to a conventional nanoimprinting process. Further, when the mold thus prepared is applied to a large PCB, the following advantages may result.

That is, through the variation in the amount of filler, the durability of the mold can be controlled in a wide range and the durability of the mold can be improved, thereby extending the lifetime of the mold. Further, a thermal expansion coefficient is decreased due to the use of the filler, and thus, dimensional stability can be assured even at high process temperatures. Furthermore, since the filler is added, the mold preparation cost can be reduced.

In addition, the present invention provides a method of manufacturing a PCB using an imprinting mold, but is not particularly limited thereto.

An imprinting mold of the present invention, having a surface structure corresponding to a plurality of via holes and a pattern to be formed, is prepared. Then, a release agent may be selectively applied on the structure of the mold, whereby the mold may be easily removed from a resin layer of a substrate without damage to the solidified resin layer in a subsequent procedure. The type of release agent may be appropriately selected depending on the material for the mold and resin layer used.

Subsequently, a substrate for a PCB, including a conductive metal layer and a semi-cured resin insulating layer laminated thereon, is prepared.

After the imprinting mold is placed on the resin insulating layer of the substrate, the imprinting mold and the resin insulating layer of the substrate are compressed together at a predetermined temperature under predetermined pressure, preferably at 50-200° C. under 0.1-20 bar, to imprint the resin insulating layer with the imprinting mold. Thereafter, the mold is removed from the substrate, to form the imprinted via holes and fine pattern, corresponding to the structure of the mold, in the resin insulating layer of the substrate.

Then, the resin insulating layer having the imprinted via holes and fine pattern is plated with a conductive metal, to form via holes and a circuit pattern for electrical connection between circuits.

As such, the conductive metal is preferably selected from the group consisting of silver, gold, platinum, palladium, copper, nickel, iron, aluminum, molybdenum, tungsten, alloys thereof, and mixtures thereof.

A better understanding of the present invention may be obtained in light of the following examples and comparative examples which are set forth to illustrate, but are not to be construed to limit the present invention.

### EXAMPLE 1

Silica having an average particle size of about 0.5 μm was surface treated with 3-glycidoxypropyltrimethoxysilane to improve the dispersibility thereof.

30 parts by weight of silica treated as above and about 10 parts by weight of a curing agent were added to 100 parts by weight of epoxy as a polymer for a mold, and then uniformly mixed together using a mixer at room temperature for about 2 hours. The resulting mixture was poured into a master mold, heat treated at about 180° C. for about 2 hours to cure it, and then removed from the master mold, to prepare an imprinting mold.

The durability modulus of the imprinting mold thus prepared was measured. The results are given in Table 1 below.

### EXAMPLE 2

Silica having an average particle size of about 0.5 μm was surface treated with 3-methylmethacrylpropyltrimethoxysilane to improve the dispersibility thereof.

30 parts by weight of silica treated as above was added to 100 parts by weight of polyester as a polymer for a mold, and then uniformly mixed using a mixer at room temperature for about 2 hours. The resulting mixture was poured into a master mold, heat treated at about 150° C. for about 2 hours to cure it, and then removed from the master mold, to prepare an imprinting mold.

The durability modulus of the imprinting mold thus prepared was measured. The results are given in Table 1 below.

### EXAMPLE 3

Silica having an average particle size of about 0.5 μm was surface treated with heptadecafluoro-1,1,2,2-tetrahydrodecyl)dimethylchlorosilane to improve the dispersibility thereof.

30 parts by weight of silica treated as above was added to 100 parts by weight of teflon as a polymer for a mold, and then uniformly mixed using a mixer at room temperature for about 2 hours. The resulting mixture was poured into a master mold, heat treated at about 150° C. for about 2 hours to cure it, and then removed from the master mold, to prepare an imprinting mold.

The durability modulus of the imprinting mold thus prepared was measured. The results are given in Table 1 below.

### EXAMPLE 4

MMT (montmorillonite) was surface treated with 3-glycidoxypropylammonium chloride to improve the dispersibility thereof.

10 parts by weight of MMT treated as above and about 10 parts by weight of a curing agent were added to 100 parts by weight of epoxy as a polymer for a mold, and then uniformly mixed together using a mixer at room temperature for about 12 hours. The resulting mixture was poured into a master mold, heat treated at about 180° C. for about 2 hours to cure it, and then removed from the master mold, to prepare an imprinting mold.

The durability modulus of the imprinting mold thus prepared was measured. The results are given in Table 1 below.

### Comparative Example 1

An imprinting mold was prepared in the same manner as in Example 1, with the exception that silica was not used.

TABLE 1

| Ex. No. | Modulus (Gpa) |
|---|---|
| 1 | 10 |
| 2 | 8.2 |
| 3 | 6.5 |
| 4 | 8.9 |
| C. 1 | 1.2 |

As is apparent from Table 1, the imprinting molds for PCBs prepared in Examples 1-4 had greatly improved durability modulus, compared to the imprinting mold without the incorporated silica filler of Comparative Example 1.

The embodiments of the present invention, regarding the imprinting mold for a PCB and the method of manufacturing a PCB using the same, have been disclosed for illustrative purposes, but are not to be construed to limit the present invention, and those skilled in the art will appreciate that various modifications, additions and substitutions are possible, without departing from the spirit of the invention.

As described hereinbefore, the present invention provides an imprinting mold for a PCB and a method of manufacturing a PCB using the same. The imprinting mold for a PCB according to the present invention is prepared by incorporating a predetermined amount of filler having a predetermined particle size into a prepolymer, and thus, has a structure, corresponding to a plurality of via holes and a pattern to be formed, having a relatively large μm size (e.g., line/space≦10 μm/10 μm, microvia≦30 μm), unlike when applied to a conventional nanoimprinting process. In addition, even though the mold thus prepared is applied to a large PCB, it can exhibit excellent durability.

That is, through variation of the amount of filler, the durability of the mold can be controlled in a wide range and the durability of the mold can be improved, resulting in extended lifetime of the mold. Further, the thermal expansion coefficient is decreased due to the use of the filler, and thus, dimensional stability can be assured even at high process temperatures. Furthermore, a mold preparation cost can be decreased by virtue of the addition of the filler.

Many modifications and variations of the present invention are possible in light of the above teachings, without departing from the scope and spirit of the invention as disclosed in the accompanying claims.

What is claimed is:

1. An imprinting mold for a printed circuit board, comprising a surface structure corresponding to a plurality of via holes and a pattern to be formed, which is prepared by incorporating 30-80 parts by weight of a filler having an average particle size of 0.1-5.0 μm into 100 parts by weight of a heat or UV curing prepolymer.

2. The imprinting mold as set forth in claim 1, wherein the prepolymer is polyurethane, polyester, silicone rubber, epoxy, teflon, or combinations thereof.

3. The imprinting mold as set forth in claim 1, wherein the filler is silica, glass frit, clay, carbon black, alumina, or combinations thereof.

4. The imprinting mold as set forth in claim 1, wherein the filler is surface treated with 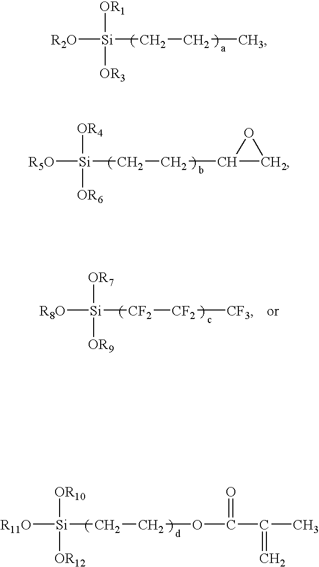
wherein, R₁ to R₁₂ are each independently an alkyl group having 1-20 carbons, and a, b, c and d are each independently an integer from 1 to 15.

5. A method of manufacturing a printed circuit board, comprising the steps of:
providing the imprinting mold according to claim 1;
providing a substrate including a conductive metal layer and a semi-cured resin insulating layer laminated thereon;
placing the imprinting mold on the resin insulating layer of the substrate, and compressing the imprinting mold at a predetermined temperature under a predetermined pressure to imprint the resin insulating layer of the substrate with the imprinting mold;
removing the imprinting mold from the substrate, to form imprinted via holes and pattern corresponding to the structure of the mold in the resin insulating layer of the substrate; and
plating the resin insulating layer having the imprinted via holes and pattern with a conductive metal, to form via holes and a circuit pattern for electrical connection between circuits.

6. The method as set forth in claim 5, further comprising the step of applying a release agent on the structure of the imprinting mold.

7. The method as set forth in claim 5, wherein the conductive metal is silver, gold, platinum, palladium, copper, nickel, iron, aluminum, molybdenum, tungsten, alloys thereof, or mixtures thereof.
